(19) United States
(12) Patent Application Publication
(10) Pub. No.: US 2015/0190766 A1
(43) Pub. Date: Jul. 9, 2015

(54) POLYMER STATIC MIXER

(71) Applicant: Charles Garner, Punta Gorda, FL (US)

(72) Inventor: Charles Garner, Punta Gorda, FL (US)

(73) Assignee: PULSAFEEDER, INC., Punta Gorda, FL (US)

(21) Appl. No.: 14/227,529

(22) Filed: Mar. 27, 2014

Related U.S. Application Data
(60) Provisional application No. 61/925,436, filed on Jan. 9, 2014.

(51) Int. Cl. B01F 5/06

(52) U.S. Cl. CPC B01F 5/0602

(57) ABSTRACT

A static mixing apparatus may include a first portion having a height; a plurality of projections extending from proximate an outside edge of the first portion towards the centerline of the first portion at about a right angle, each projection having a first side at about a right angle to a second side, the first and second sides converging at an apex, the plurality of projections arranged to form an opening between the sides of the projections, and the opening having an inlet side and an outlet side. The static mixing apparatus may be substantially cylindrical.

### CROSS-REFERENCE TO RELATED APPLICATIONS

This application claims the benefit of U.S. Provisional Application No. 61/925,436, titled Polymer Static Mixer, filed Jan. 9, 2014, which is herein incorporated by reference.

### BACKGROUND

Mixing devices can be generally divided into two types: dynamic or mechanical mixers and static mixers. Dynamic mixers have one or more moving parts to facilitate the desired mixing of materials. Static mixers are stationary and achieve adequate mixing of materials without any significant moving parts.

Static mixers, also called motionless mixers, are utilized for mixing one or more fluids flowing through a pipe or conduit, or for mixing one or more liquid, solid, or powder substances into a fluid flow. Static mixing devices are usually fixed within, or form part of, the conduit or pipe. Typically, static mixers are designed to achieve a high degree of mixing with a low pressure drop or loss across the static mixer.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In one implementation, a static mixing apparatus may include a first portion having a height; a plurality of projections extending from proximate an outside edge of the first portion towards the centerline of the first portion at about a 90° angle, each projection having a first side at about a 90° angle to a second side, the first and second sides converging at an apex, the plurality of projections arranged to form an opening between the sides of the projections, and the opening having an inlet side and an outlet side. The static mixing apparatus may be substantially cylindrical. The first portion may be substantially cylindrical.

In another implementation, a static mixing apparatus may include a base portion; and a plate portion positioned transverse to the base portion, the plate portion including a plurality of openings having an inlet side and an outlet side, and one or more of the plurality of openings extending in the radial direction and having a first end proximate the outside edge of the plate portion and a second end offset from the center of the plate portion. The base portion may be substantially cylindrical. The plate portion may be substantially cylindrical.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIG. 1 is a schematic diagram of an exemplary polymer makedown system described herein, according to some implementations.

FIG. 2 a schematic diagram of an exemplary polymer makedown system described herein, according to some implementations.

FIG. 3 is a perspective view of an injector described herein, according to some implementations.

FIG. 4A is a perspective view of a static mixing apparatus described herein, according to some implementations.

FIG. 4B is a perspective view of a static mixing apparatus described herein, according to some implementations.

FIG. 5 is a perspective view of a static mixing chamber described herein, according to some implementations.

FIG. 6 is a cross-sectional view illustrating a portion of a polymer makedown system described herein, according to some implementations.

FIG. 7 is a perspective view illustrating an exemplary implementation of a static mixing apparatus and an insert described herein, according to some implementations.

FIG. 8 is a cross-sectional view illustrating an exemplary implementation of a static mixing apparatus described herein, according to some implementations.

FIG. 9 is a cross-sectional view illustrating an exemplary implementation of a static mixing apparatus described herein, according to some implementations.

FIG. 10A is a top view of a static mixing apparatus described herein, according to some implementations.

FIG. 10B is a top view of a static mixing apparatus described herein, according to some implementations.

FIG. 10C is a top view of a static mixing apparatus described herein, according to some implementations.

FIG. 10D is a top view of a static mixing apparatus described herein, according to some implementations.

FIG. 10A is a top view of a static mixing apparatus described herein, according to some implementations.

FIG. 10B is a top view of a static mixing apparatus described herein, according to some implementations.

FIG. 10C is a top view of a static mixing apparatus described herein, according to some implementations.

FIG. 10D is a top view of a static mixing apparatus described herein, according to some implementations.

FIG. 11A is a top view of a static mixing apparatus described herein, according to some implementations.

FIG. 11B is a top view of a static mixing apparatus described herein, according to some implementations.

FIG. 11C is a top view of a static mixing apparatus described herein, according to some implementations.

FIG. 11D is a top view of a static mixing apparatus described herein, according to some implementations.

FIG. 12A is a top view of a static mixing apparatus described herein, according to some implementations.

FIG. 12B is a top view of a static mixing apparatus described herein, according to some implementations.

FIG. 13A is a top view of a static mixing apparatus described herein, according to some implementations.

FIG. 13B is a top view of a static mixing apparatus described herein, according to some implementations.

FIG. 14A is a top view of a static mixing apparatus described herein, according to some implementations.

FIG. 14B is a top view of a static mixing apparatus described herein, according to some implementations.

FIG. 14C is a top view of a static mixing apparatus described herein, according to some implementations.

FIG. 14D is a top view of a static mixing apparatus described herein, according to some implementations.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices may be shown in block diagram form in order to facilitate describing the claimed subject matter.

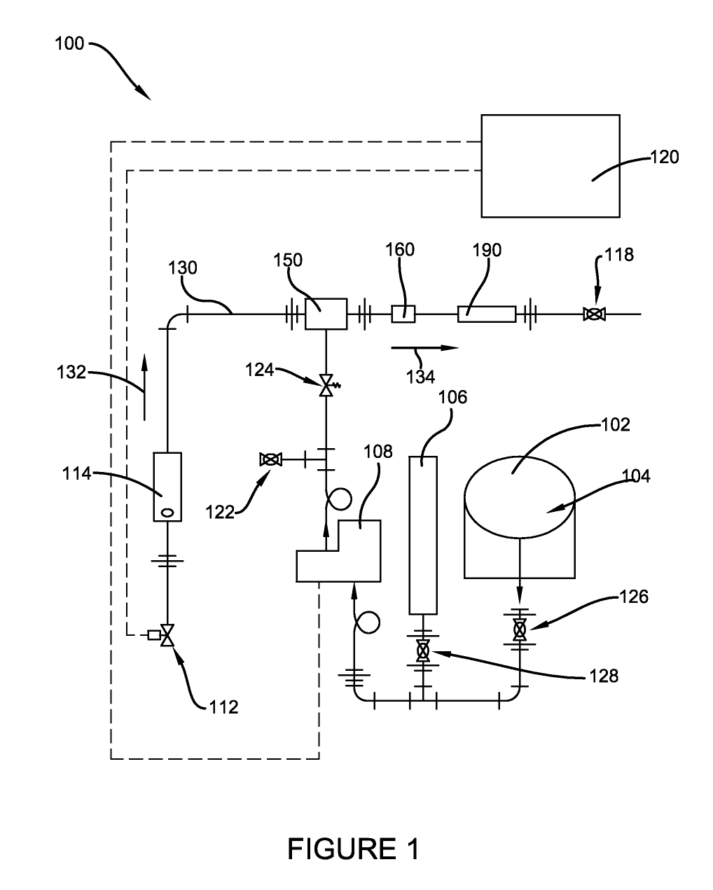

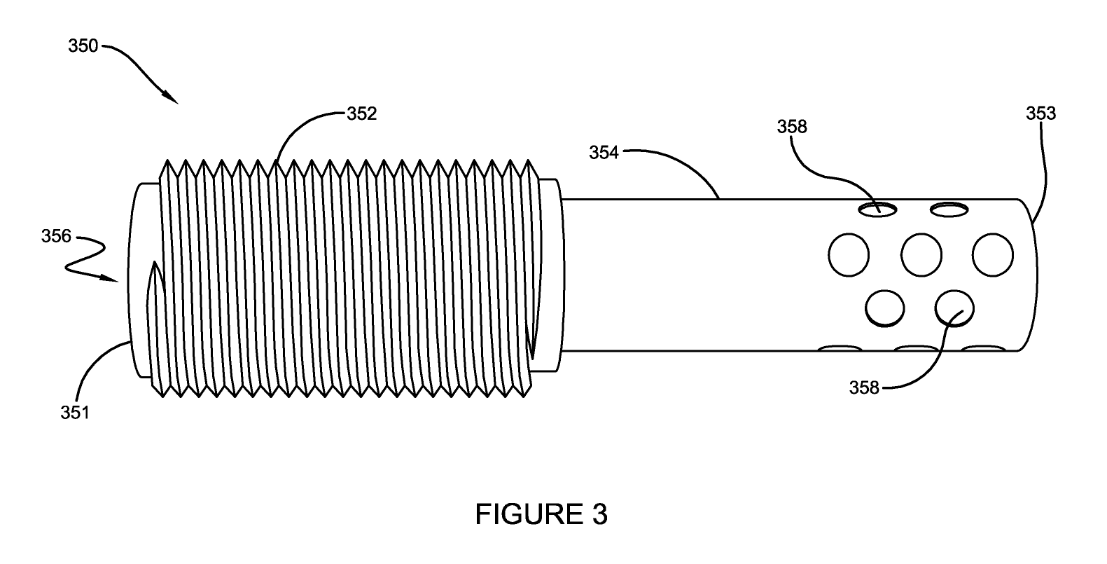

FIG. 1 illustrates an exemplary polymer makedown system 100, according to one implementation. Polymer makedown, or inversion, is the process of wetting and expanding polymer chains. Polymers can be in a dry powder form, a liquid emulsion form, or a liquid dispersion form. A polymer in a liquid emulsion form, referred to as a neat polymer, can be in a liquid emulsion, for example an oil emulsion or water-in-oil emulsion. A polymer in a liquid dispersion form can be in a liquid solution, for example a brine solution. A liquid emulsion polymer must undergo the polymer makedown or inversion process before the polymer is ready for use. The polymer makedown system 100 shown in FIG. 1 is a manual system. The polymer makedown system 100 may include a polymer tank 102, a calibration column 106, a pump 108, an injector or injection quill 150, a water supply inlet valve 112, a flow meter or rotameter 114, a static mixing apparatus 160, a static mixing chamber 190, an outlet valve 118, controls 120, an air bleed valve 122, a pressure relief and backflow preventer valve 124, and conduit or pipes 130 fluidly connecting the system components. The polymer tank 102 may hold a liquid emulsion polymer, or neat polymer, 104 and may be fluidly connected to the system by a valve 126. A calibration column 106 may calibrate the desired quantity, amount, or flow rate of the neat polymer 104 and may be fluidly connected to the system 100 by valve 128. The pump 108 may generate flow of the neat polymer 104 from the polymer tank 102 through the conduit 130 to the injector 150. The inlet valve 112 may provide a flow of a fluid or a liquid, for example water, 132 to the system 100. The flow meter 114 may measure the flow rate of the fluid 132 within the system 100. The injector 150 may inject or otherwise introduce the neat polymer 104 into the fluid 132 creating a mixture 134 of fluid 132 and neat polymer 104, thus diluting the neat polymer 104. The static mixing apparatus 160 may mix and agitate the flow of mixture 134. The static mixing apparatus 160 may at least partially restrict the flow of mixture 134 and increase the head loss, as described in more detail below. The static mixing apparatus 160 may maximize the addition of energy to the flow and the inversion of the emulsion polymer 104 without shearing the polymer chains. The static mixing apparatus 160 may increase the pressure of the flow of mixture 134 upstream from the static mixing apparatus 160. The static mixing chamber 190 may further mix and agitate the neat polymer 104 and fluid 132 in the flow of mixture 134. The outlet valve 118 may fluidly connect the system 100 to external conduits or piping (not shown). The controls 120 may control and be in electrical communication with the inlet valve 112 and the pump 108. For example, the controls 120 may adjust the flow rate of the inlet valve 112 or the pump 108, or both. Any of the apparatus described in FIGS. 3-14 can be used in the polymer makedown system 100.

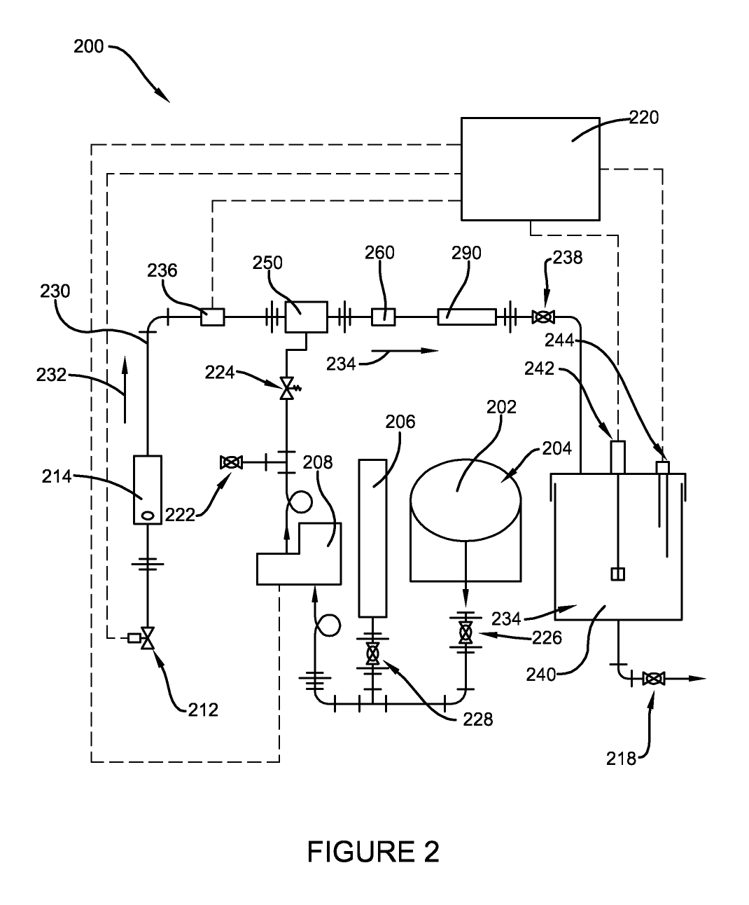

FIG. 2 illustrates an exemplary polymer makedown system 200, according to one implementation. The polymer makedown system 200 shown in FIG. 2 is an automatic system. The polymer makedown system 200 may include a polymer tank 202, a calibration column 206, a pump 208, an injector or injection quill 250, a water supply inlet valve 212, a flow meter or rotameter 214, a static mixing apparatus 260, a static mixing chamber 290, an outlet valve 218, controls 220, an air bleed valve 222, a pressure relief and backflow preventer valve 224, a flow sensor 236, and conduit or pipes 230 fluidly connecting the system components. The polymer tank 202 may hold a liquid emulsion polymer, or neat polymer, 204 and may be fluidly connected to the system 200 by a valve 226. A calibration column 206 may calibrate the desired quantity, amount, or flow rate of the neat polymer 204 and may be fluidly connected to the system 200 by valve 228. The pump 208 may generate flow of the neat polymer 204 from the polymer tank 202 through the conduit 230 to the injector 250. The inlet valve 212 may provide a flow of a fluid or a liquid, for example water, 232 to the system 200. The flow meter 214 may measure the flow rate of the fluid 232 within the system 200. The injector 250 may inject or otherwise introduce the neat polymer 204 into the fluid 232 creating a mixture 234 of fluid 232 and neat polymer 204, thus diluting the neat polymer 204. The static mixing apparatus 260 may mix and agitate the flow of mixture 234. The static mixing apparatus 260 may at least partially restrict the flow of mixture 234 and increase the head loss, as described in more detail below. The static mixing apparatus 260 may maximize the addition of energy to the flow of mixture 234 and maximize the inversion of the emulsion polymer 204 without shearing the polymer chains. The static mixing apparatus 260 may increase the pressure of the flow of mixture 234 upstream from the static mixing apparatus 260. The static mixing chamber 290 may further mix and agitate the neat polymer 204 and fluid 232 in the flow of mixture 234. The outlet valve 218 may fluidly connect the system 200 to external conduits or piping (not shown). The polymer makedown system 200 may also include and a polymer makedown tank 240. The flow of mixture 234 may exit the static mixing chamber 290, pass through a valve 238, and enter the polymer makedown tank 240. The tank 240 may include a mixer 242 and a level sensor 244. The controls 220 may control and be in electrical communication with the inlet valve 212, the pump 208, the mixer 242, and the level sensor 244. For example, the controls 220 may adjust the flow rate of the inlet valve 212 or the pump 208, or both. The controls 220 may turn the mixer 242 on and off or adjust the speed of the mixer 242. The controls 220 may receive a signal from the level sensor 244 when the mixture reaches a certain level, and the controls 220 may then adjust the flow rate of the inlet valve 212 or the pump 208, or both. Any of the apparatus described in FIGS. 3-14 can be used in the polymer makedown system 200.

FIG. 3 illustrates an injector or injection quill 350, according to one implementation. The injector 350 may include a threaded portion 352 near a first end 351 and a smooth portion 354 near a second end 353. The injector 350 may be substantially cylindrical and may include an orifice 356 extending through the length. The smooth portion 354 may include one or more orifices 358, which are fluidly connected to orifice 356, such that a fluid may enter the orifice 356 at the first end 351, travel through the injector 350, and exit the one or more orifices 358 and orifice 356 at the second end 353.

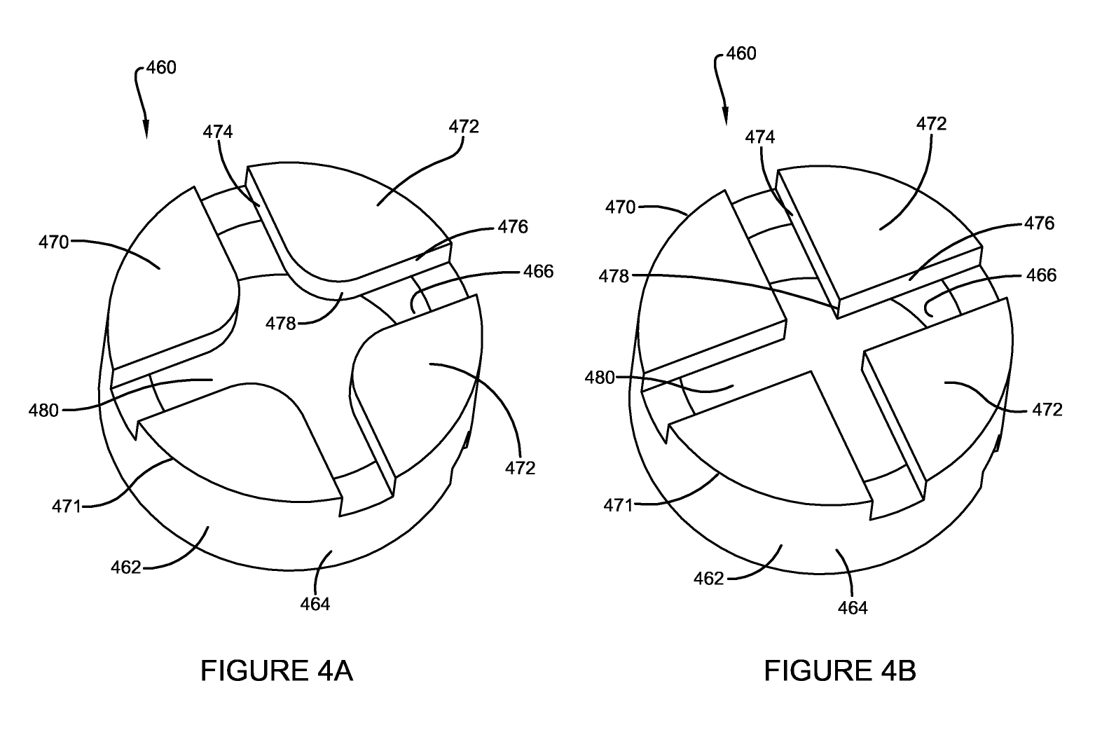

FIG. 4A illustrates a static mixing apparatus 460, according to one implementation. FIG. 4B illustrates a static mixing apparatus 460, according to one implementation. The static mixing apparatus 460 may be substantially cylindrical. The static mixing apparatus 460 may have a variety of other shapes including, but not limited to, triangular, rectangular, square, pentagonal, hexagonal, other multi-sided polygon, oval, and elliptical. The static mixing apparatus 460 may include a base portion 462 and a plate portion 470. The base portion 462 and the plate portion 470 may be integral forming one component or may be two separate components joined together. The plate portion 470 may be positioned transverse to the base portion 462. The base portion 462 may be substantially cylindrical and may include an outer wall 464 and an inner wall 466. The base portion 462 may have a variety of other shapes including, but not limited to, triangular, rectangular, square, pentagonal, hexagonal, other multi-sided polygon, oval, and elliptical. The plate portion 470 may be substantially cylindrical and may include an outer wall 471 and one or more projections 472. The plate portion 470 may have a variety of other shapes including, but not limited to, triangular, rectangular, square, pentagonal, hexagonal, other multi-sided polygon, oval, and elliptical. The outer wall 471 of the plate portion 470 may be congruent with the outer wall 464 of the base portion 462. The plate portion 470 may include one or more projections 472 extending from proximate the outer wall 464 of the base portion 462 towards the centerline of the base portion 462 at about a 90° angle to the outer wall 464 of the base portion 462. In some exemplary implementations, the plate portion 470 may include four projections 472. The projections 472 may be the same size and shape or different sizes or shapes. Some projections 472 could be the same size or shape and other projections 472 could be different sizes or shapes. A projection 472 may include a first side 474 and a second side 476 converging at an apex 478. The first and second sides 474, 476 may converge to form an angle. In some exemplary implementations, the first and second sides 474, 476 converge to form about a 90° angle. The first side 474 of one projection 472 may be substantially parallel to the second side 476 of another projection 472. The apex 478 may have a radius of curvature, as shown in FIG. 4A. The apex 478 may have any radius of curvature chosen by a person of ordinary skill in the art. In some exemplary implementations, the apex 478 has a 0.010″ radius of curvature, or a 0.0625″ radius of curvature, or a 0.125″ radius of curvature. The radius of curvature of the apex 478 may vary upon a wide variety of factors. In some implementations, the radius of curvature of the apex 478 may vary depending upon one or more of the following factors: the size or configuration of the static mixing apparatus 460, the size or shape of the projection 472, the size or diameter of the base portion 462, and the size or diameter of the plate portion 470. The apex 478 may form a tip or point, as shown in FIG. 4B. In some exemplary implementations, the apex 478 forms a tip or point at a right angle. The apex 478 may have any radius of curvature that extends from the outer wall 471 on the first side 474 of the plate portion 470 to the outer wall 471 on the second side 476 of the plate portion 470. The projections 472 may be arranged to form an opening 480 in the plate portion 470 between the projections 472. The opening 480 may extend through the outer wall 471 of the plate portion 470, the outer wall 464 of the base portion 462, or both at one or more locations or positions. The opening 480 may extend from the centerline of the base portion 462 to the outer wall 464 of the base portion 462 at four separate locations or positions about 90° apart. The center of the opening 480 and the centerline of the base portion 462 may be collinear or may be offset. The opening 480 may have a substantially plus sign shape.

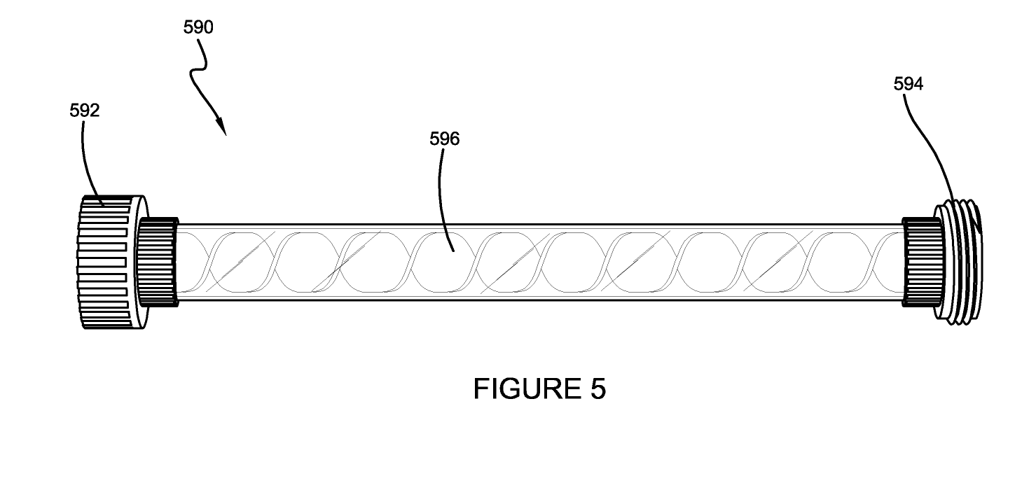

FIG. 5 illustrates a static mixing chamber 590, according to one implementation. The static mixing chamber 590 may include a first end 592 having female threaded and a second end 594 having male threads for positioning the chamber 590 within a conduit or pipe. The static mixing chamber 590 may include one or more vanes 596 along a portion of the length, or along the entire length of the chamber 590. The vanes 596 are positioned to mix a fluid passing through the static mixing chamber 590.

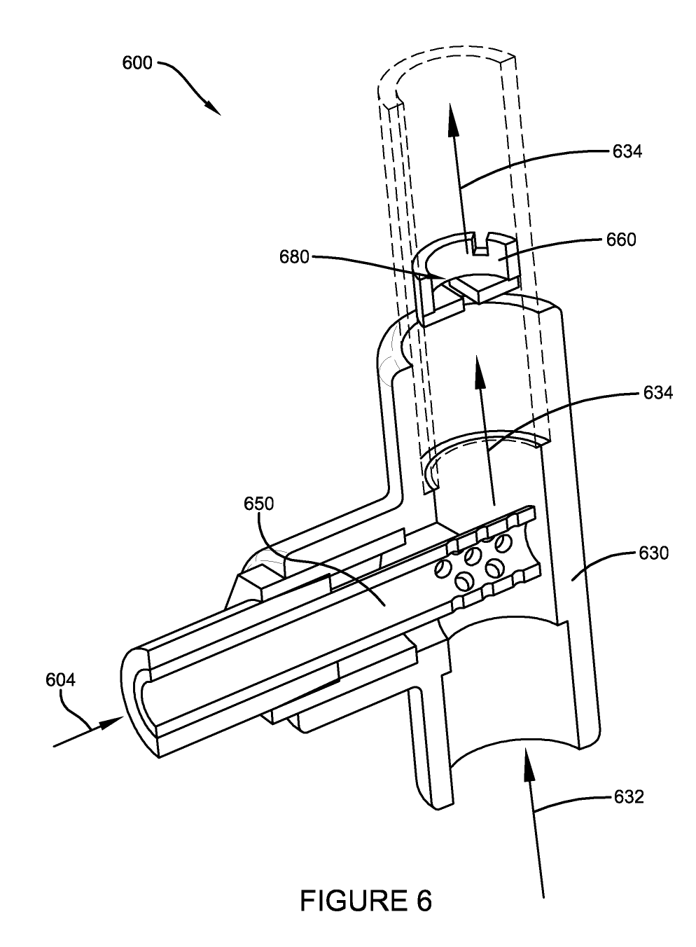

FIG. 6 is a cross-sectional view illustrating a portion of a polymer makedown system 600, according to one implementation. The polymer makedown system 600 may include an injector or injection quill 650, a static mixing apparatus 660, and conduit or piping 630. A fluid or a liquid, such as water, 632 flows through the conduit 630. The injector 650 may inject or otherwise introduce an emulsion polymer or neat polymer 604 into the flow of fluid 632 at an adjustable rate, diluting the neat polymer 604 and creating a mixture 634. The mixture 634 then passes through the opening 680 in the static mixing apparatus 660, which mixes the neat polymer 604 with the fluid 632 and agitates the neat polymer 604, wetting and expanding the polymer chains. The static mixing apparatus 660 may function to accomplish one or more of the following: restrict the flow of the mixture 634, increase head loss of the flow of the mixture 634, increase the pressure of the flow of the mixture 634 upstream from the static mixing apparatus 660, and reduce the velocity of the flow of the mixture 634. The static mixing apparatus 660 may mix and agitate the water 632 and neat polymer 604 in the mixture 634 without shearing the polymer chains.

The flow rate of the fluid 632 in the polymer makedown system 600 may be any flow rate chosen by a person of ordinary skill in the art. In some exemplary implementations, the flow rate of the fluid 632 may be from 0.5 gallons per minute (gpm), or less, to 15 gpm, or more. The flow rate of the fluid 632 may vary upon a wide variety of factors. In some implementations, the flow rate of the fluid 632 may vary depending on one or more of the following factors: the size, layout or configuration of the polymer makedown system 600, the diameter of the conduits or piping 630 used in the polymer makedown system 600, the size or diameter of the static mixing apparatus 660, the size or diameter of the injector 650, the size or diameter of the static mixing chamber 590 (shown in FIG. 5), and the type or size of pump 108 (shown in FIG. 1) or pump 208 (shown in FIG. 2). The velocity of the flow of the mixture 634 passing through the opening 680 in the static mixing apparatus 660 may be greater than the velocity of the flow of fluid 634 preceding the static mixing apparatus 660. In one implementation, the velocity of the flow of fluid 634 passing through the opening 680 in the static mixing apparatus 660 is greater than three times the velocity of the flow of fluid 634 preceding the static mixing apparatus 660. In other implementations, the velocity of the flow of fluid 634 passing through the opening 680 in the static mixing apparatus 160 is greater than the velocity of the flow of fluid 634 preceding the static mixing apparatus 160 by one or more of the following factors: two or more times three or more times, four or more times, five or more times, six or more times, seven or more times, eight or more times, nine or more times, and ten or more times. This increase in velocity of the flow of fluid 634 passing through the opening 680 in the static mixing apparatus 660 may cause the flow of fluid 634 to transition from laminar flow to transient flow, from laminar flow to turbulent flow, or from transient flow to turbulent flow. Laminar flow is defined as flow having a Reynolds number less than 2300. Transient flow is defined as flow having a Reynolds number between 2300 and 4000. Turbulent flow is defined as flow having a Reynolds number greater than 4000.

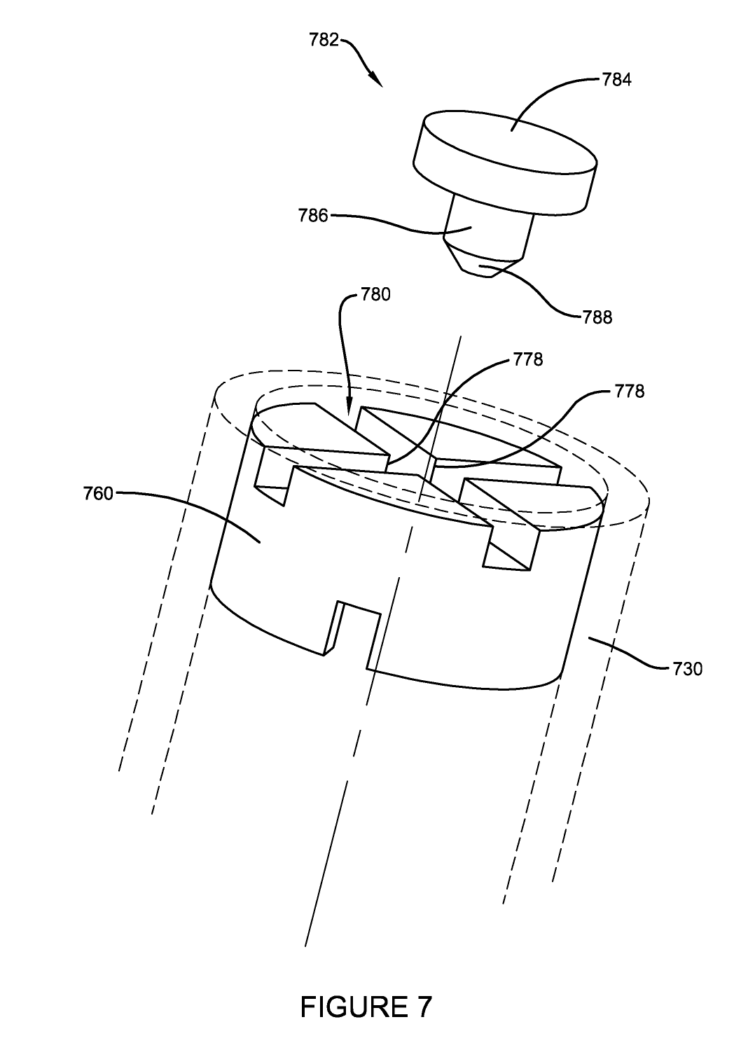

FIG. 7 illustrates an exemplary implementation of a static mixing apparatus 760 and an insert 782, according to one implementation. The static mixing apparatus 760 may be positioned within a conduit or pipe 730 such that substantially all of the flow within the conduit 730 passes through the static mixing apparatus 760. The static mixing apparatus 760 may be positioned within a conduit 730 such that the centerline of the static mixing apparatus 760 is substantially parallel to the flow. The static mixing apparatus 760 may be positioned within a conduit 730 such that the centerline of the static mixing apparatus 760 is substantially collinear with the centerline of the conduit 730. The insert 782 may be substantially cylindrical with a head portion 784, a body portion 786, and a tapered end 788. The head portion 784 may be larger than the body portion 786. The insert 782 may have a variety of other shapes including, but not limited to, triangular, rectangular, square, pentagonal, hexagonal, other multi-sided polygon, oval, and elliptical. The tapered end 788 may assist when inserting or positioning the insert 782 into an opening 780 of the static mixing apparatus 760. The head portion 784 and the body portion 786 may have any diameter chosen by a person of ordinary skill in the art. In some exemplary implementations, the head portion 784 has a diameter of 0.30″ or 0.40″. The insert 782 may be positioned between the apexes 778 of the static mixing apparatus 760. The body portion 786 may be dimensioned to fit securely between the apexes 778 of the static mixing apparatus 760. The head portion 784 may be dimensioned to limit deep the insert 782 is inserted into the opening 780 of the static mixing apparatus 760. The head portion 784 may be dimensioned to limit or restrict the flow through the static mixing apparatus 760. The insert 782 may be substantially solid and prevent any fluid flow from passing through the insert 782; or the insert 782 may have varying degrees of porosity and allow some fluid flow to pass through it. When a substantially solid insert 782 is positioned within an opening 780 of the static mixing apparatus 760, the flow passes around the insert 782 through the unobstructed portions of the opening 780. When a substantially solid insert 782 is positioned within the opening 780 at the center of the static mixing apparatus 760, the insert 782 at least partially obstructs the flow along the centerline of the static mixing apparatus 760. In some implementations, the insert 782 is positioned at the center of the static mixing apparatus 760 and obstructs the flow along the centerline of the static mixing apparatus 760. The flow may continue to pass through the unobstructed portions of the opening 780.

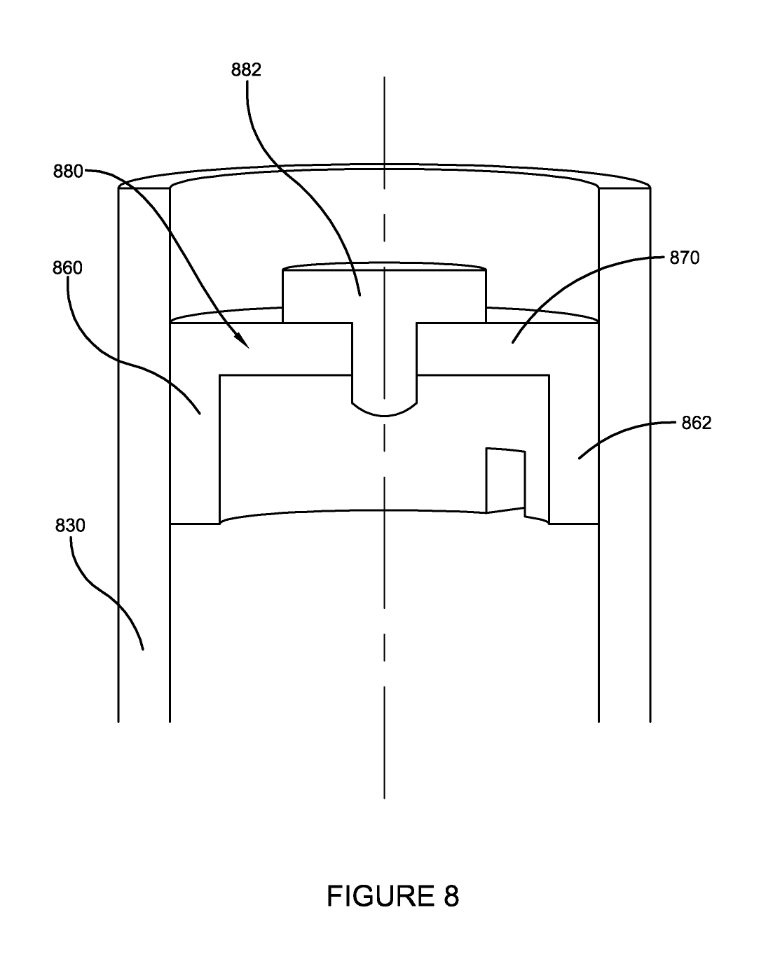

FIG. 8 illustrates a cross-sectional view of an exemplary implementation of a static mixing apparatus 860 and an insert 882, according to one implementation. The static mixing apparatus 860 is positioned with a pipe or conduit 830 such that substantially all of the flow in the conduit 830 passes through the static mixing apparatus 860. In some implementations, all of the flow in the conduit 830 passes through the static mixing apparatus 860. The flow in the conduit 830 may be in either direction, from the top downward or from the bottom upward. The static mixing apparatus 860 may include a base portion 862 and a plate portion 870 positioned at one end of the base portion 862. The insert 882 may be positioned within a portion of the opening 880 along the centerline of the static mixing apparatus 860. In some implementations, the centerline of the conduit 830, the centerline of the static mixing apparatus 860, and the centerline of the insert 882 are collinear.

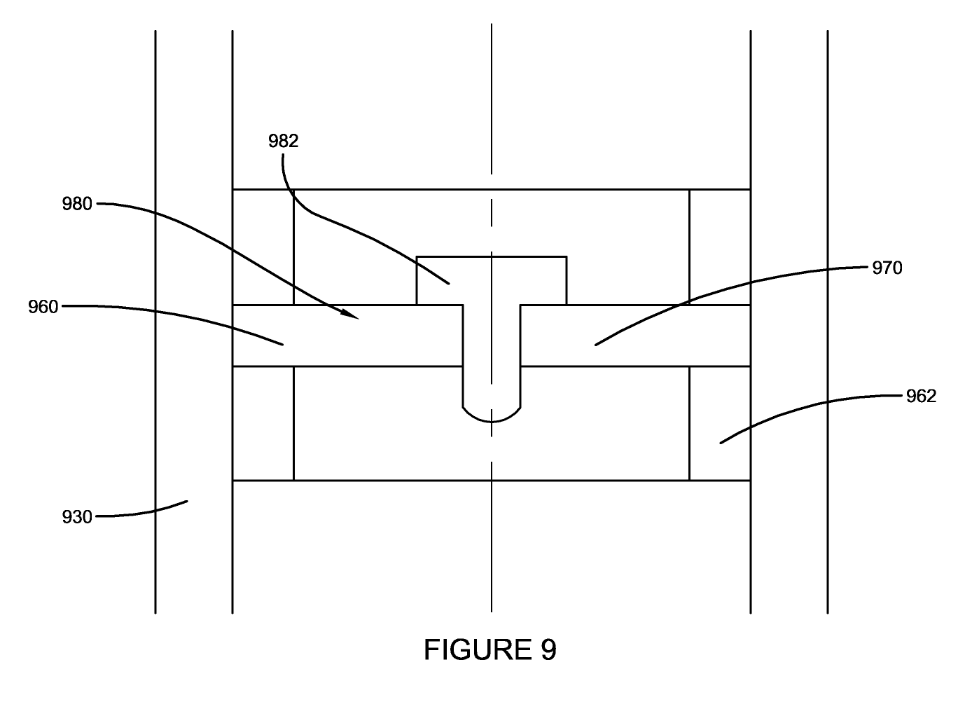

FIG. 9 illustrates a cross-sectional view of an exemplary implementation of a static mixing apparatus 960 and an insert 982, according to one implementation. The static mixing apparatus 960 is positioned with a pipe or conduit 930 such that substantially all of the flow in the conduit 930 passes through the static mixing apparatus 960. The flow in the conduit 930 may be in either direction, from the top downward or from the bottom upward. The static mixing apparatus 960 may include a base portion 962 and a plate portion 970 positioned between the ends of the base portion 962. In some implementations, the plate portion 970 is positioned substantially equidistant from the ends of the base portion 962. The insert 982 may be positioned within a portion of the opening 980 along the centerline of the static mixing apparatus 960. In some implementations, the centerline of the conduit 930, the centerline of the static mixing apparatus 960, and the centerline of the insert 982 are collinear.

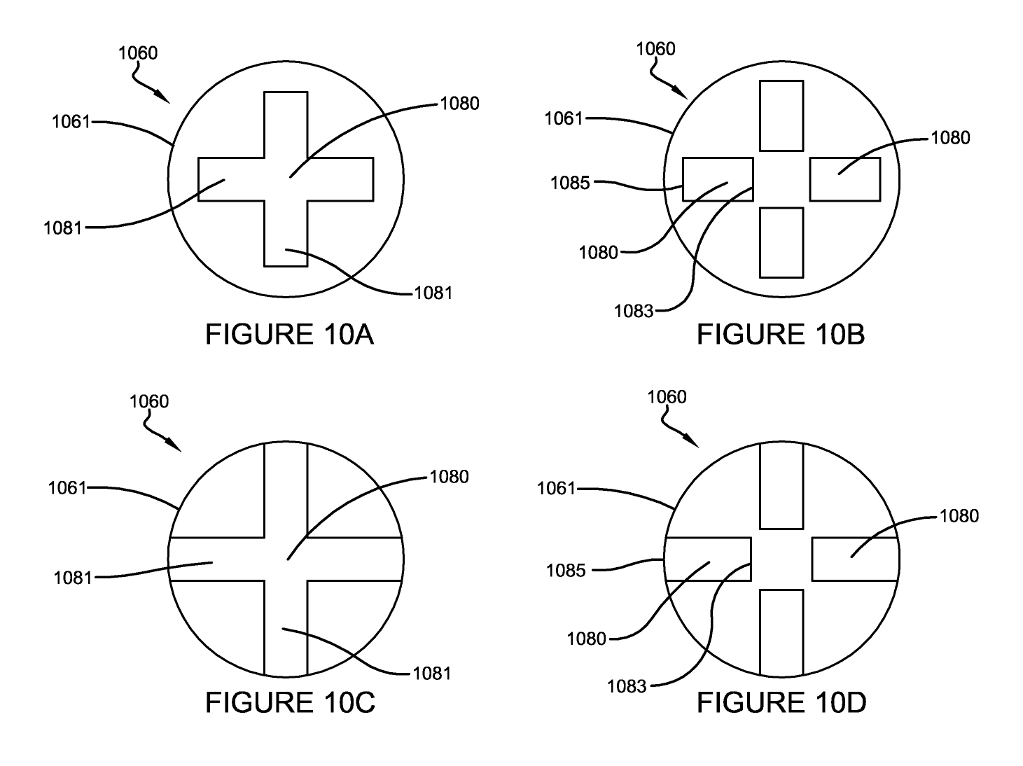

FIGS. 10A, 10B, 10C, and 10D illustrate several top views of a static mixing apparatus 1060, according to some implementations. The static mixing apparatus 1060 may include an opening 1080 having one or more extensions 1081, as shown in FIGS. 10A and 10C. The extensions 1081 may extend from the center a portion of the distance towards the outside edge 1061 of the static mixing apparatus 1060, as shown in FIG. 10A. The extensions 1081 may extend from the center to the outside edge 1061 of the static mixing apparatus 1060, as shown in FIG. 10C. The extensions 1081 may have the same lengths and widths, or different lengths or widths. The extensions 1081 may have substantially uniform widths or may taper at one end or the other. The static mixing apparatus 1060 may include one or more openings 1080 extending in the radial direction, as shown in FIGS. 10B and 10D. The one or more openings 1080 may include a first end 1083 offset from the center of the static mixing apparatus 1060 and a second end 1085 offset from the outside edge 1061 of the static mixing apparatus 1060, as shown in FIG. 10B. The one or more openings 1080 may a first end 1083 offset from the center of the static mixing apparatus 1060 and a second end 1085 proximate to or contiguous with the outside edge 1061 of the static mixing apparatus 1060, as shown in FIG. 10D. The one or more openings 1080 may have the same lengths and widths, or different lengths or widths. The openings 1080 may have substantially uniform widths or may taper at one end or the other.

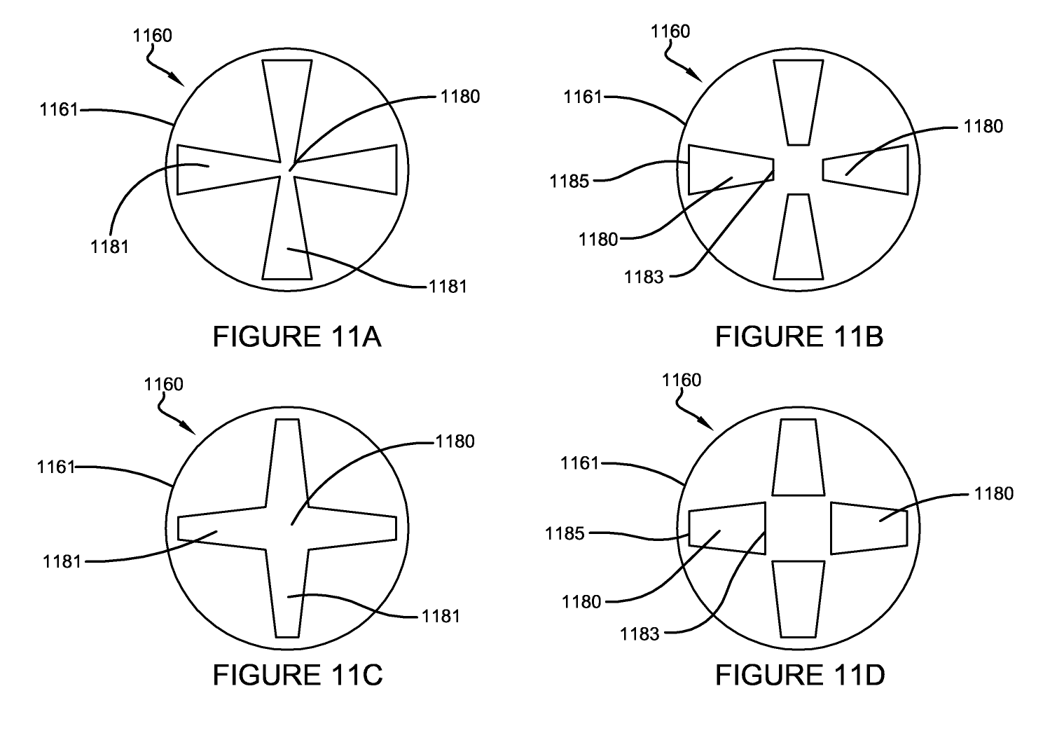

FIGS. 11A, 11B, 11C, and 11D illustrate several top views of a static mixing apparatus 1160, according to some implementations. The static mixing apparatus 1160 may include an opening 1180 having one or more extensions 1181, as shown in FIGS. 11A and 11C. The extensions 1181 may extend from the center a portion of the distance towards the outside edge 1161 of the static mixing apparatus 1160, as shown in FIG. 11A. The extensions 1181 may extend from the center to the outside edge 1161 of the static mixing apparatus 1160, as shown in FIG. 11C. The extensions 1181 may all be the same size and shape or different sizes and shapes. The extensions 1181 may taper such that the extensions 1181 are wider near the outside edge 1161 and narrower near the center of the static mixing apparatus 1160, as shown in FIG. 11A. Conversely, the extensions 1181 may taper such that the extensions 1181 are narrower near the outside edge 1161 and wider near the center of the static mixing apparatus 1160, as shown in FIG. 11C. The static mixing apparatus 1160 may include one or more openings 1180 extending in the radial direction, as shown in FIGS. 11B and 11D. The one or more openings 1180 may include a first end 1183 offset from the center of the static mixing apparatus 1160 and a second end 1185 offset from the outside edge 1161 of the static mixing apparatus 1160, as shown in FIG. 11B. The one or more openings 1180 may have a first end 1183 offset from the center of the static mixing apparatus 1160 and a second end 1185 proximate to or contiguous with the outside edge 1161 of the static mixing apparatus 1160, as shown in FIG. 11D. The openings 1180 may taper such that the openings 1180 are wider near the outside edge 1161 and narrower near the center of the static mixing apparatus 1160, as shown in FIG. 11B. Conversely, the openings 1180 may taper such that the openings 1180 are narrower near the outside edge 1161 and wider near the center of the static mixing apparatus 1160, as shown in FIG. 11D.

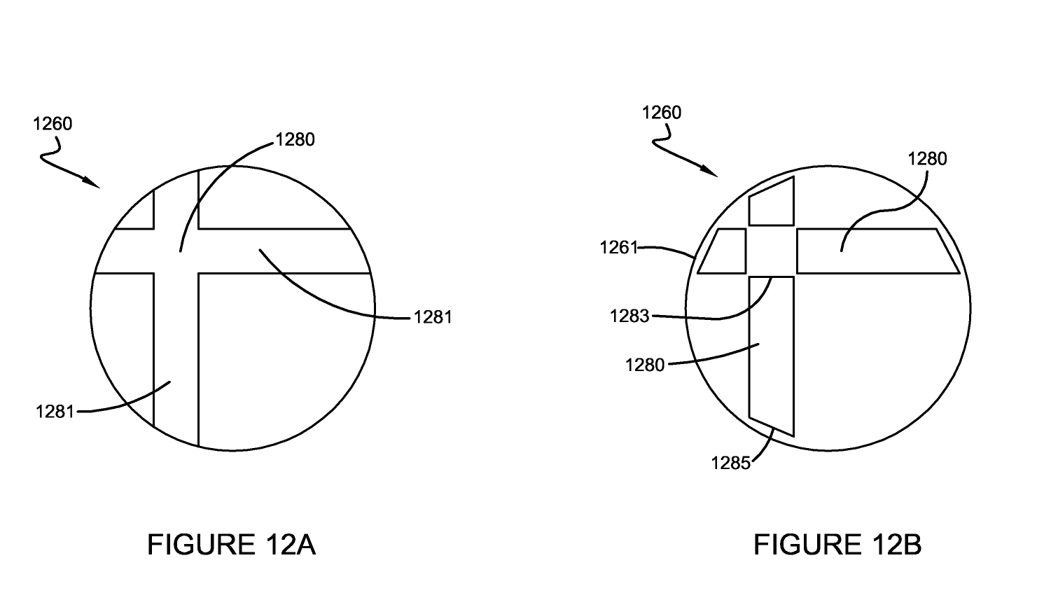

FIGS. 12A and 12B illustrate top views of a static mixing apparatus 1260, according to some implementations. The static mixing apparatus 1260 may have an opening 1280 with one or more extensions 1281. The opening 1280 may be offset from the center of the static mixing apparatus 1260, as shown in FIG. 12A. The static mixing apparatus 1260 may have one or more openings 1280 extending from proximate an outside edge 1261 inward to a location offset from the center of the static mixing apparatus 1260, as shown in FIG. 12B. The openings 1280 may have a first end 1283 positioned a set distance from the center of the static mixing apparatus 1260 and a second end 1285 proximate to, contiguous with, near to, or offset from the outside edge 1261 of the static mixing apparatus 1260.

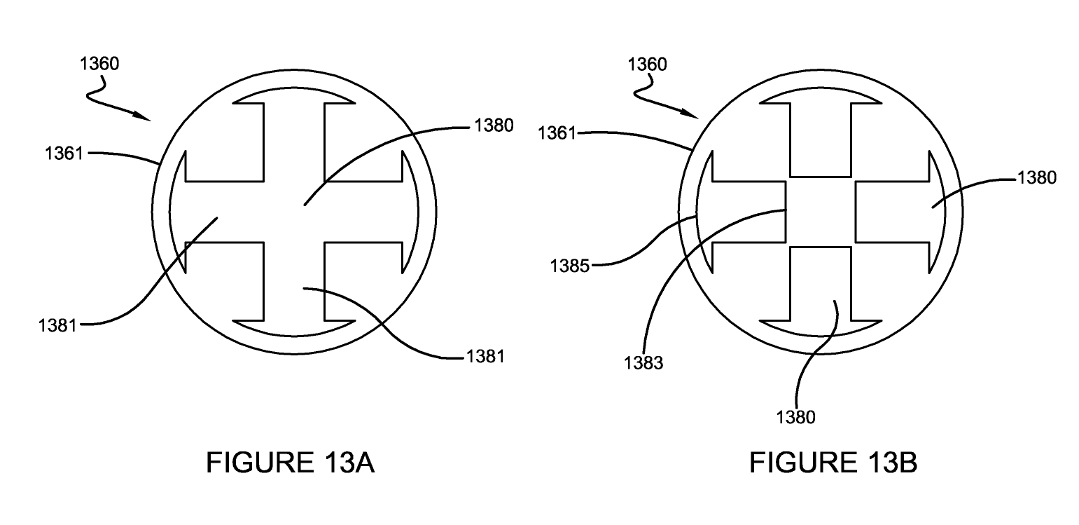

FIGS. 13A and 13B illustrate top views of a static mixing apparatus 1360, according to some implementations. The static mixing apparatus 1360 may have an opening 1380 with one or more extensions 1381, as shown in FIG. 13A. The extensions 1381 may have a wider cross section near an outside edge 1361 of the static mixing apparatus 1360, as shown in FIG. 13A. The static mixing apparatus 1360 may include one or more openings 1380 extending in the radial direction, as shown in FIG. 13B. The one or more openings 1380 may a first end 1383 offset from the center of the static mixing apparatus 1360 and a second end 1385 offset from, proximate to, or contiguous with the outside edge 1361 of the static mixing apparatus 1360. The second end 1385 of the opening 1380 may have a wider portion than the first end 1383 of the opening 1380, as shown in FIG. 13B.

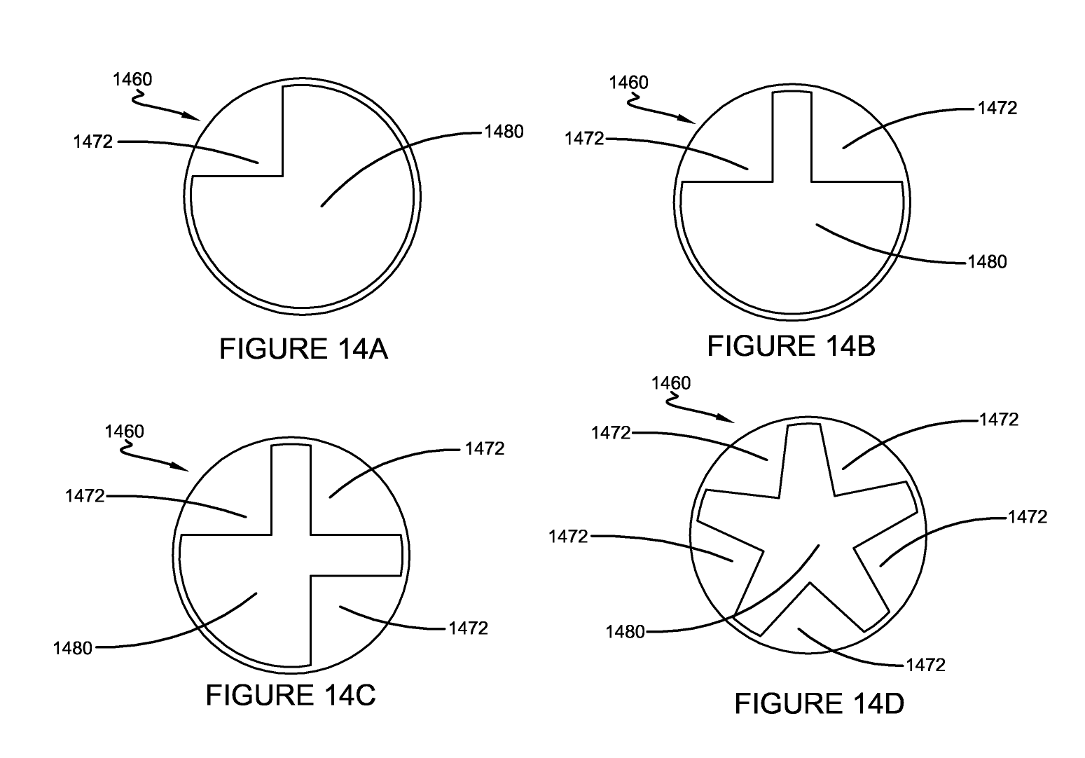

FIGS. 14A, 14B, 14C, and 14D illustrate several top views of a static mixing apparatus 1460, according to some implementations. The static mixing apparatus 1460 may include an opening 1480 and any number of projections 1472. In some implementations, the static mixing apparatus 1460 may include one projection 1472, as shown in FIG. 14A, two projections 1472, as shown in FIG. 14B, three projections 1472, as shown in FIG. 14C, four projections 1472, as shown previously, or five projections 1472, as shown in FIG. 14D. As discussed above, the projections 1472 may have two sides that form a 90° angle. The two sides of the projections 1472 for form a tip or point or rounded end. The projections 1472 can be arranged in any manner around the perimeter of the static mixing apparatus 1460. In some implementations, the projections 1472 are equally spaced around the perimeter of the static mixing apparatus 1460. In other implementations, the projections 1472 are grouped together creating a larger opening 1480 on the opposite side of the perimeter.

With reference again to FIG. 1, a method, process, or system of inverting an emulsion polymer 104, using any one or more of the implementations described herein, may include one or more of the following steps. The method may include initiating a flow of fluid 132 through a conduit 130 in a polymer makedown system 100. The method may include injecting an emulsion polymer 104 through a dispersion injector 150 into the flow of fluid 132, diluting the emulsion polymer 104. The method may include agitating the emulsion polymer 104 by transporting the flow of fluid 134 through an opening of a static mixing apparatus 160. The method may include agitating the emulsion polymer 104 by transporting the flow of fluid 134 through a static mixing chamber 190 having multiple vanes. The method may include reducing the velocity and increasing the pressure of the flow of fluid 134 upstream from the static mixing apparatus 160. The method may include mixing the emulsion polymer 104 with the fluid 132 in the static mixing apparatus 160 without shearing the polymer chains. The method may include restricting the flow of fluid 134 along the centerline of the static mixing apparatus 160 by obstructing the center of the opening of the static mixing apparatus 160. The method may include increasing the velocity of the flow of fluid 134 passing through the opening in the static mixing apparatus 160 by a factor of three or more times. The above described methods, processes, and systems also apply to the polymer makedown system 200 in FIG. 2.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

Numerous implementations have been described herein. It will be apparent to those skilled in the art that the above methods and apparatuses may incorporate changes and modifications without departing from the general scope of what is described herein. It is intended to include all such modifications and alterations in so far as they come within the scope of the appended claims or the equivalents thereof.

What is claimed is:

1. A static mixing apparatus comprising:
a first portion having a height;
a plurality of projections extending from proximate an outside edge of the first portion towards the centerline of the first portion at about a 90° angle, each projection having a first side at about a 90° angle to a second side, the first and second sides converging at an apex, the plurality of projections arranged to form an opening between the sides of the projections, the opening having an inlet side and an outlet side.

2. The static mixing apparatus of claim 1, wherein the apex has a radius of curvature.

3. The static mixing apparatus of claim 1, wherein the opening extends through the outside edge of the first portion.

4. The static mixing apparatus of claim 1, wherein the plurality of projections are substantially the same size.

5. The static mixing apparatus of claim 1, wherein the plurality of projections includes four projections.

6. The static mixing apparatus of claim 5, wherein the opening extends from the centerline of the first portion to the outside edge of the first portion at four separate locations about 90° apart, and the center of the opening and the centerline of the first portion are collinear.

7. The static mixing apparatus of claim 1, further comprising:
an insert located within the opening between the apexes of the projections, the insert being substantially solid.

8. A static mixing apparatus comprising:
a base portion; and
a plate portion positioned transverse to the base portion, the plate portion including a plurality of openings having an inlet side and an outlet side, one or more of the plurality of openings extending in the radial direction and having a first end proximate the outside edge of the plate portion and a second end offset from the center of the plate portion.

9. A static mixing apparatus of claim 8, wherein the center of the plate portion is substantially solid.

10. A static mixing apparatus of claim 8, wherein the second end of one or more of the plurality of openings is offset from the center of the plate portion by about a third of the radius of the plate portion.

11. The static mixing apparatus of claim 8, wherein the first end of one or more of the plurality of openings extends through the outside edge of the plate portion.

12. A static mixing apparatus of claim 8, wherein the plurality of openings have substantially uniform widths.

13. A static mixing apparatus of claim 8, wherein the plurality of openings have substantially equal shapes.

14. A static mixing apparatus of claim 8, wherein the plurality of openings are equally spaced around the center of the plate portion.

15. A static mixing apparatus of claim 8, wherein the plurality of openings includes four openings.

16. A method of mixing a substance comprising the steps of:
initiating a fluid flow through a conduit;
injecting an emulsion polymer through a dispersion injector into the fluid flow;
agitating the emulsion polymer by transporting the fluid flow through an opening of a static mixing apparatus, the opening having a plurality of extensions extending in a radial direction from proximate the centerline to proximate the outside edge of the static mixing apparatus; and
agitating the emulsion polymer by transporting the fluid flow through a static mixing chamber having multiple vanes.

17. The method of claim 16, wherein the step of agitating the emulsion polymer by transporting the fluid flow through an opening of a static mixing apparatus, further comprises reducing the velocity and increasing the pressure of the fluid flow upstream from the static mixing apparatus.

18. The method of claim 16, wherein the step of agitating the emulsion polymer by transporting the fluid flow through an opening of a static mixing apparatus further comprises mixing the emulsion polymer with the fluid without shearing the polymer chains.

19. The method of claim 16, wherein the step of agitating the emulsion polymer by transporting the fluid flow through an opening of a static mixing apparatus further comprises restricting the fluid flow along the centerline of the static mixing apparatus by obstructing the center of the opening and allowing fluid to pass through the extensions of the opening.

20. The method of claim 16, wherein the plurality of extensions form a substantially plus sign shape.
